(19) United States
(12) Patent Application Publication
(10) Pub. No.: US 2021/0137254 A1
(43) Pub. Date: May 13, 2021

(54) BUOYANCY DEVICE FOR MOBILE PHONE

(71) Applicant: Carol Diane CASEY, Dearborn, MI (US)

(72) Inventor: Carol Diane CASEY, Dearborn, MI (US)

(21) Appl. No.: 16/682,632

(22) Filed: Nov. 13, 2019

(51) Int. Cl. A45F 5/10

(52) U.S. Cl. CPC A45F 5/10; A45F 2005/008; A45F 2200/0516

(57) ABSTRACT

A buoyancy device for securing an object such as a mobile phone. The buoyancy device has a buoyant member having a flexible body with first and second ends and an imaginary longitudinal axis. When the ends are brought together the buoyant member forms a ring that can be engaged by a boat hook or by a user's hand. Extending outwardly beyond the first and second ends is a tether with first and second distal end portions. To secure the mobile device, a connector is provided with an anchor end to which the tether is secured. Also extending from the connector is an ear that is adapted to engage the mobile device so that an engagement force that secures the object to the ear exceeds the weight of the object.

### BACKGROUND

### (1) Technical Field

In several aspects, the disclosed buoyancy device protects a mobile phone from loss when dropped into the water of a marine environment.

### (2) Background

When a mobile phone is dropped in a lake for example while boating, not only may an expensive device be lost, but if retrieved, it may be inoperative.

### SUMMARY

Against this background, disclosed herein is a buoyancy device for securing an object such as a mobile phone. The buoyancy device has a buoyant member having a flexible body with first and second ends and an imaginary longitudinal axis. When the ends are brought together the buoyant member forms a ring that can be engaged by a boat hook or by a user's hand.

Extending outwardly beyond the first and second is a tether with first and second distal end portions. A central portion passes substantially along the longitudinal axis of the buoyant member so that the central portion of the tether is at least partially encapsulated by the buoyant member.

To secure the mobile device, a connector is provided with an anchor end to which at least one of the first and second distal end portions of the tether is secured. Also extending from the connector is an ear that is adapted to engage the mobile device so that an engagement force that secures the object to the ear exceeds the weight of the object.

If dropped into a body of water, the mobile phone may sink below the surface because the phone has a specific gravity that exceeds that of the water. But its downward submerged path is limited by the tether that becomes under tension. At its upper end, the tether is secured to the buoyant member that remains on the water's surface. At its lower end is the connector, to which the mobile phone is attached.

With the aid of the buoyancy device, the mobile phone can be retrieved if dropped into a body of water by a user's hand or a boat hook grasping the buoyant member and pulling the phone out of the water.

If such actions are taken fairly promptly, further damage to the phone may be avoided and it may become usable without incurring the cost of replacement.

### BRIEF DESCRIPTION OF THE DRAWINGS

FIG. 1 is a perspective, exploded view of a representative embodiment of a buoyancy device for a mobile phone.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed is a buoyancy device for securing an object such as a smartphone. Conventionally, such phones are provided with a charging port that may receive a charging cable. In one embodiment, the buoyancy device has a buoyant member having a flexible body with first and second ends. Between the ends, an imaginary longitudinal axis can be considered to extend.

Along the longitudinal axis lies a tether having first and second distal end portions that extend outwardly beyond the first and second ends of the buoyant member. A central portion of the tether passes substantially along the longitudinal axis of the buoyant member so that the central portion of the tether is at least partially encapsulated by the buoyant member.

In alternative embodiments, the tether may be wrapped around the buoyant member or otherwise tied thereto. In such embodiments, an interim manufacturing step of molding a foam around the tether in a die or other cavity is avoided.

Secured to the tether is a connector with an anchor end to which at least one of the first and second distal end portions of the tether is attached. Attachment of the tether to the connector may be provided by a suitable knot. Alternatively, attachment may be provided by a weldment of the ends of the tether to the anchor end of the connector.

At another portion of the connector is an ear that is adapted to engage the mobile phone so that an engagement force that secures the object to the ear of the connector exceeds the weight of the phone under atmospheric conditions or the apparent weight of the phone if submerged.

The first and second ends of the buoyant member are united so that the buoyant member forms a ring that is adapted to be positioned over a user's wrist or held by a user's hand. This configuration enables the buoyancy device and thus the mobile phone can be retrieved by a user's hand or foot or a hook.

In an alternative embodiment, the anchor end of the connector defines an orifice through which either or both the first and second distal ends of the tether may pass before being affixed to each other and thus secured to the connector.

Preferably, the ear of the connector is selected from the group consisting of a USB-C connector, a micro USB connector, a lightning connector and similar or comparable connectors. Such connectors include those that are adapted to engage a mobile or smart phone for charging through a power cable.

It will be appreciated that in some embodiments, the ends of the tether include a knot by which its ends are secured to each other and/or to the anchor end of the connector

Alternatively, the distal ends of the tether include a weldment positioned between the end portions of the buoyant member and the connector.

In some embodiments, the connector is generally quadrilateral, elliptical, oval or circular in shape. Regardless of shape, the connector can be considered to have a ring-facing edge, a smartphone-facing edge and intermediate side edges that extend between the ring-facing edge and the object-facing edge.

To engage the tether, several embodiments of the connector include an orifice lies proximate the ring-facing edge. To detachably engage the smartphone charging port, the ear of the connector extends from the smartphone-facing edge.

In cases where a knot is deployed, the knot is a knot is configured to be untied so that alternative connectors can be secured to one or both distal ends of the tether. In this sense the buoyancy device can be considered as universal in that one buoyancy device may engage one or more of the same or different models of smartphones without needing to exchange connectors.

It will be appreciated that in further alternative embodiments, connectors can be configured so that they may have ears that are adapted to engage objects other than smartphones, such as an iPad or other devices with charging ports to which an ear may be attached.

Accordingly, in several embodiments, multiple connectors are simultaneously secured to the distal ends of the tether so that smartphones with differently configured charging ports can be attached to the buoyancy device without needing to untie the tether.

For ease of manufacturing, the buoyant member can be made of a foam or other materials that float and not deteriorate in a marine environment. For example, the buoyancy device may include polyethylene.

In an alternative embodiment, for ready identification when in the water the buoyancy device may include a vinyl coating that covers at least part of the buoyant member. The coating may offer a substrate to which various colors or signage may be provided.

In light of this description, it will be appreciated that a method is provided of enabling retrieval of a smartphone that sinks in a body of water or other fluid. One way to practice related method steps is by:
1. providing a ring-shaped buoyant member having a flexible body with first and second end portions and a longitudinal axis;
2. securing a tether to the buoyant member so that first and second distal end portions of the tether extend beyond the first and second end portions of the buoyant member;
3. attaching a connector to the first and/or second ends of the tether;
4. configuring the connector with an anchor end to which at least one of the first and second distal end portions of the tether is secured and an ear;
5. inserting the ear into a charging port of the smartphone so that an engagement force that secures the smartphone to the connector exceeds the weight of the smartphone; and
6. ensnaring the ring-shaped buoyant member by hand, foot or a hook.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A buoyancy device for securing an object, the buoyancy device having:
a buoyant member having a flexible body with first and second ends and a longitudinal axis;
a tether having first and second distal end portions that extend outwardly beyond the first and second ends and a central portion that passes substantially along the longitudinal axis of the buoyant member so that the central portion of the tether is at least partially encapsulated by the buoyant member;
a connector with
an anchor end to which at least one of the first and second distal end portions of the tether is secured; and
an ear that is adapted to engage the object
so that an engagement force that secures the object to the ear of the connector exceeds the weight of the object.

2. The buoyancy device of claim 1, wherein:
the first and second ends of the buoyant member are united
so that the buoyant member forms a ring that is adapted to positioned over a user's wrist or held by a user's hand; and
so that the buoyancy device can be retrieved by a user's hand or foot or a hook.

3. The buoyancy device of claim 1, wherein the anchor end of the connector defines an orifice through which either or both the first and second distal ends of the tether may pass before being affixed to each other and thus secured to the connector.

4. The buoyancy device of claim 1, wherein the connector is selected from the group consisting of a USB-C connector, a micro USB connector and a lightning connector.

5. The buoyancy device of claim 1, wherein the ends of the tether include a knot.

6. The buoyancy device of claim 1, wherein the distal ends of the tether include weldment positioned between the end portions of the buoyant member and the connector.

7. The buoyancy device of claim 1, wherein the connector is generally quadrilateral in shape, with
a ring-facing edge;
an object-facing edge; and
a pair of side edges that extend between the ring-facing edge and the object-facing edge.

8. The buoyancy device of claim 7, wherein
the orifice lies proximate the ring-facing edge.

9. The buoyancy device of claim 7, wherein the ear extends from the object-facing edge.

10. The buoyancy device of claim 5, wherein
the knot is a knot is configured to be untied so that alternative connectors can be secured to one or both distal ends of the tether.

11. The buoyancy device of claim 1, wherein multiple connectors are simultaneously secured to the distal ends of the tether so that smartphones with differently configured charging ports can be attached to the buoyancy device without needing to untie the tether.

12. The buoyancy device of claim 1, wherein the object is a smartphone.

13. The buoyancy device of claim 1, wherein the buoyant member includes a foam.

14. The buoyancy device of claim 13, wherein the foam includes polyethylene.

15. The buoyancy device of claim 13, further including a coating that covers at least part of the buoyant member.

16. A method of enabling retrieval of a smartphone that sinks in a body of water or other fluid comprising the steps of:
a. providing a ring-shaped buoyant member having a flexible body with first and second end portions and a longitudinal axis;
b. securing a tether to the buoyant member so that first and second distal end portions of the tether extend beyond the first and second end portions of the buoyant member;
c. attaching a connector to the first and/or second ends of the tether, the connector having
i. an anchor end to which at least one of the first and second distal end portions of the tether is secured; and
ii. an ear;
d. inserting the ear into a charging port of the smartphone so that an engagement force that secures the smartphone connector exceeds the weight of the smartphone; and
e. ensnaring the ring-shaped buoyant member by hand, foot or a hook.
